(19) United States
(12) Patent Application Publication
(10) Pub. No.: US 2004/0126206 A1
(43) Pub. Date: Jul. 1, 2004

(54) Mini-environment system and operating method thereof

(75) Inventors: Shinichi Araya, Tokyo (JP); Toshihiko Miyajima, Tokyo (JP); Hideaki Watanabe, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TDK CORPORATION, Tokyo (JP)

(21) Appl. No.: 10/330,114

(22) Filed: Dec. 30, 2002

(51) Int. Cl. B65G 1/00

(52) U.S. Cl. 414/217

(57) ABSTRACT

The invention is intended to prevent, in a local clean system, attachment of particles to a wafer, which would occur when the wafer is taken out from a clean box. To achieve the object, an operating method of a local clean system including a processing apparatus, a load port annexed thereto and a clean box set to the load port, comprises the steps of, setting the clean box on the load port, opening a communication path between the load port and the processing apparatus, opening, after said communication path is opened fully, the clean box and bringing a cassette in which a wafer is accommodated inside the clean box into an interior of the load port, and taking the wafer out of the cassette and transferring the wafer into the interior of the processing apparatus.

### BACKGROUND OF THE INVENTION

1. Field of the Invention

The present invention relates to a mini-environment system using a clean box in which an article(s) to be transferred, such as a semiconductor wafer etc., is stored and transferred under a clean condition, which may be used in manufacturing processes for semiconductor devices, electronic parts and related goods, and optical disks etc. Specifically, the present invention relates to a mini-environment system that uses a clean box that is so configured that an article(s) is brought into/out from the clean box through an aperture formed at its bottom. The present invention also relates to a load port that is to be used as a part of that system.

2. Related Background Art

Recently, in manufacturing processes that require a high level clean environment, such as manufacturing processes for semiconductor devices, a mini-environment method or a local clean space method has been adopted, in which a large scale clean room is not constructed but only the ambient environment of the products is kept under a clean condition. That is in short, only the interior of each processing apparatus for performing each process in the course of the manufacturing is kept under a clean condition, and transfer and storing of the processed articles between the processing apparatus are performed using containers whose interiors are kept clean. Such a container is called a clean box or a pod.

The pod is generally categorized into two types, namely, a pod that has an opening at its side and a pod that has an opening at its bottom. The present invention relates to a mini-environment system (i.e. a local clean system) that use a pod that has an opening at the bottom.

Each processing apparatus is provided with an additional apparatus called a load port. The pod is mounted on the load port, and the door or lid of the pod is opened, so that the article(s) to be processed such as a wafer(s) accommodated in the pod is brought out from the pod or an article(s) having been processed is brought back to the interior of the pod. In the following, an example of a conventional mini-environment system that uses a pod that has an opening at the bottom will be described.

FIGS. 6A to 6C are drawings sequentially illustrating a part of a process in an example of a conventional mini-environment system, in which a pod is opened and articles to be processed in the form of semiconductor wafers are brought out from the pod. Referring to FIG. 6A, the system comprises a processing apparatus 120, a load port 110 provided on the front side of the processing apparatus, and a pod (or a clean box) 100.

The load port 110 has an outer cover 114 fixed to the processing apparatus 120 and an elevator (or up-and-down) portion 112 that can slide up and down inside the outer cover 114. The pod 100 is placed on a pod base 112a formed on the top face of the elevator portion 112. The pod 100 is composed of a pod body 102 in the form of a box that has an opening at its bottom, a lid 104 that closes the opening of the pod body 102, and a cassette (or a wafer rack) 106 arranged on the lid 104. A plurality of semiconductor wafers are accommodated in the cassette 106 basically in parallel with each other with equal spaces. At the top of the processing apparatus 120, there is provided an air intake fan device 122 having a filter. The air intake fan device 122 is generating a down flow of air ceaselessly in the processing apparatus 120. The down flow of air is exhausted, together with dust in the apparatus, from the bottom of the apparatus to the exterior, so that the cleanness in the interior of the apparatus would be enhanced.

The top face of the elevator portion 112 of the load port has an opening, which is closed by a cassette base 116. The cassette base 116 is a part of a lid opening/closing mechanism for opening and closing the lid of the pod. There are various systems for securing the lid 104 of the pod to the pod body 102, such as a latch system using a latch(es) or a suction system using a vacuum suction space etc., and there are various structures for opening and closing the lid in accordance with the securing systems, though detailed descriptions and illustrations thereof are omitted here.

As shown in FIG. 6A, the pod 100 is set on the load port in such a way that the lid 104 of the pod 100 is aligned with the cassette base 116 of the load port. When the pod is set or mounted, the lid opening/closing mechanism releases a securing engagement of the lid 104 and the pod body 106. Next, the elevator portion 112 of the load port is elevated as shown in FIG. 6B. Then, only the pod body 102 is elevated with the elevator portion 112, while the lid 104 of the pod remains, together with the cassette, on the cassette base 116.

On the other hand, the elevator portion 112 of the load port and the processing apparatus 120 have openings on their respective side wall facing to the other. That is, the elevator portion of the load port 112 has an opening 112b and the processing apparatus 120 has an opening 126. In the state shown in FIG. 6A, these openings are displaced in the vertical direction. As the elevator portion 112 is elevated, the openings eventually overlap with each other, and in the state shown in FIG. 6C in which the elevator portion 112 is at its uppermost position, the openings are aligned with each other to provide a transfer path for wafers between the load port and the processing apparatus. Under this state, a robot arm 124 provided in the processing apparatus picks up wafers in the wafer rack 106 so as to carry them to a processing stage (not shown) in the body 130 of the processing apparatus.

In the above-described prior art system, the opening 112b of the load port and the opening 126 of the processing apparatus gradually align with each other, as the elevator portion 112 of the load port is elevated. This means that the opened area through which the interior spaces of the load port and the processing apparatus communicate with each other is gradually opened (or enlarged). In the course of that process, down-flowing air in the processing apparatus flows also into the load port as shown by arrows in FIGS. 6B and 6C. Such changes in the air flow involved by the gradual enlargement of the open area cause blowing-up of dust. In addition, since the cassette on which the wafers are accommodated is at a position where the cassette is exposed to the air flow flowing from the processing apparatus to the load port. So there is a problem that particles would attach to the wafers.

Furthermore, in the conventional structure as shown in FIGS. 6A to 6C, a part of the mechanism for elevating the pod body 102 is required to be arranged above the position of the wafers. So there is another problem that the particles generated in a sliding portion in that mechanism would attach to the wafers.

### SUMMARY OF THE INVENTION

An object of the present invention is to eliminate or reduce attachment of particle to a wafer as described above, in a mini-environment system that uses a pod having an opening at the bottom.

In order to achieve the above object, according to the present invention, there is provided an operating method of a local clean system including a processing apparatus, a load port annexed thereto and a clean box set to the load port, comprising the steps of:

setting the clean box on the load port;

opening a communication path between the load port and the processing apparatus;

opening, after the communication path is opened fully, the clean box and bringing a cassette in which a wafer is accommodated inside the clean box into an interior of the load port; and

taking the wafer out of the cassette and transferring the wafer into the interior of the processing apparatus.

As one mode of such method, there is provided an operating method of a local clean system that includes a processing apparatus, a load port annexed thereto and a clean box set to the load port, wherein the processing apparatus has an opening on its side that faces the load port, the load port is provided with a movable housing portion having a top surface to which the clean box is to be set and movable up and down in the vertical direction, the movable housing portion has an aperture on its side that faces the processing apparatus, the positional relationship between the opening of the processing apparatus and the opening of the movable housing portion is arranged in such a way that when the movable housing portion is at a predetermined elevated position, both the openings are aligned with each other to form a communication path between the load port and the processing apparatus, and the clean box includes a body in the form of a box having an opening at its bottom, a lid closing the opening of the body and a cassette for accommodating a wafer disposed on the lid, comprising the steps of:

setting the clean box on the top surface of the movable housing portion of the load port under the state in which the movable housing portion is at a predetermined lowered position;

elevating the movable housing portion up to the elevated position to open the communication path between the load port and the processing apparatus, and retaining the movable housing portion at that position;

opening, under the above-described state, the lid of the clean box and lowering the lid and the cassette thereon to bring them into the interior of the load port; and

picking up the wafer from the cassette and transferring it to the processing apparatus.

Furthermore, according to the present invention, there is also provided a local clean system comprising:

a processing apparatus;

a load port annexed thereto; and

a clean box set to the load port, wherein the processing apparatus has an opening on its side that faces the load port;

the load port is provided with a movable housing portion having a top surface to which the clean box is to be set and movable up and down in the vertical direction, an up-and-down drive mechanism that moves the movable housing portion up and down, and a stopper for retaining the movable housing portion at a predetermined elevated position, the movable housing portion having an aperture on its side that faces the processing apparatus, the positional relationship between the opening of the processing apparatus and the opening of the movable housing portion being arranged in such a way that when the movable housing portion is at a predetermined elevated position, both the openings are aligned with each other to form-a communication path between the load port and the processing apparatus; and

the clean box includes a body in the form of a box having an opening at its bottom, a lid closing the opening of said body and a cassette for accommodating a wafer disposed on the lid.

In this local clean system, it is preferable that the system be constructed in such a way that the up-and-down drive mechanism can lower the lid of the clean box set on the top surface of the movable housing portion downward together with the cassette disposed thereon under the state in which the movable housing portion is retained by the stopper at its elevated position, to bring them into the interior of the load port so that said cassette and said communication path would be at substantially the same height.

More specifically, such a system may be constructed in such a way that an opening is provided on the top surface of said movable housing portion, and the load port has a cassette base that closes the opening on the top surface of the movable housing portion, and the up-and-down drive mechanism is joined to the cassette base so that when the cassette base is elevated the movable housing portion would be pushed up together with the cassette base, and it is possible to lower the cassette base only together with the lid of the clean box and the cassette while the movable housing portion is retained by the stopper at the elevated position.

Still further, according to the invention there is also provided a load port for use in a local clean system in conjunction with a processing apparatus, comprising:

a movable housing portion having a top surface to which a clean box is to be set and movable up and down in the vertical direction;

an up-and-down drive mechanism that moves said movable housing portion up and down; and

a stopper for retaining the housing at a predetermined elevated position;

wherein the movable housing portion having an aperture on its side that faces the processing apparatus, the opening is configured in such a way that when the movable housing portion is at a predetermined elevated position, the opening is aligned with an opening of the processing apparatus to form a communication path between the load port and the processing apparatus, and the load port can lower the lid of the clean box set on the top surface of the movable housing portion downward together with a cassette disposed thereon under the state in which the movable housing portion is retained by the stopper at its elevated position to bring them into the interior of the load port so that said cassette and said communication path would be at substantially the same height

Preferably the load port may be constructed in such a way that an opening is provided on the top surface of the movable housing portion, and the load port has a cassette base that closes the opening on the top surface of the movable housing portion, and the up-and-down drive mechanism is joined to said cassette base so that when the cassette base is elevated the movable housing portion would be pushed up together with the cassette base, and that it is possible to lower the cassette base only together with the lid of the clean box and the cassette while the movable housing portion is retained by the stopper at the elevated position.

In the local clean system, the operating method thereof and the load port according to the present invention as described above, the clean box is opened and the cassette is brought into the load port after the communication path between the load port and the processing apparatus is opened, namely, under the state in which the movable housing is retained at a predetermined elevated position and the communication path between the load port and the processing apparatus has been formed into a constant size. Therefore, the airflow to which the wafers accommodated in the cassette are exposed inside the load port has been already stabilized. Thus, the possibility of wafer contamination due to blowing-up of particles caused by disturbance of airflow is reduced.

Furthermore, in the local clean system and the load port according to the present invention, the up-and-down drive mechanism can be structured to push up the movable housing from beneath the position of the clean box or the cassette base, which means that the up-and-down drive mechanism does not exist above the cassette. Therefore, the possibility of wafer contamination with the particle generated by sliding of parts in that mechanism is low.

### BRIEF DESCRIPTION OF THE DRAWINGS

FIG. 1 is a drawing showing a mini-environment system of a semiconductor processing apparatus as an embodiment of the present invention under a state in which a movable housing is at its lowered position.

FIG. 2 is a drawing showing the mini-environment system of a semiconductor processing apparatus as an embodiment of the present invention under a state in which the movable housing is at its elevated position.

FIG. 3 is a drawing showing the mini-environment system of a semiconductor processing apparatus as an embodiment of the present invention under a state in which a cassette base has been lowered.

FIG. 4 is a plan view of the system shown in FIGS. 1 to 3, in which pod guides and a pod lock mechanism are illustrated.

FIGS. 5A, 5B and 5C are drawings schematically showing the state of air flow in the system shown in FIGS. 1 to 3 under the respective states.

FIGS. 6A, 6B and 6C are drawings sequentially showing a part of a process in an example of a conventional mini-environment system, in which a pod is opened and articles to be processed in the form of semiconductor wafers are brought out from the pod.

### DETAILED DESCRIPTION OF THE PREFERRED EMBODIMENT

In the following, an embodiment of the present invention will be described with reference to the annexed drawings.

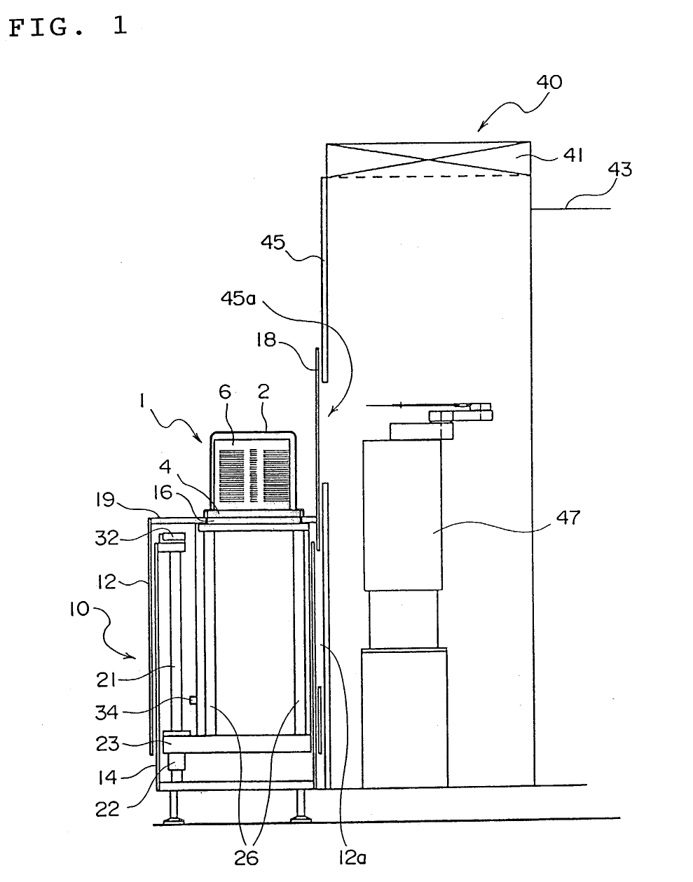

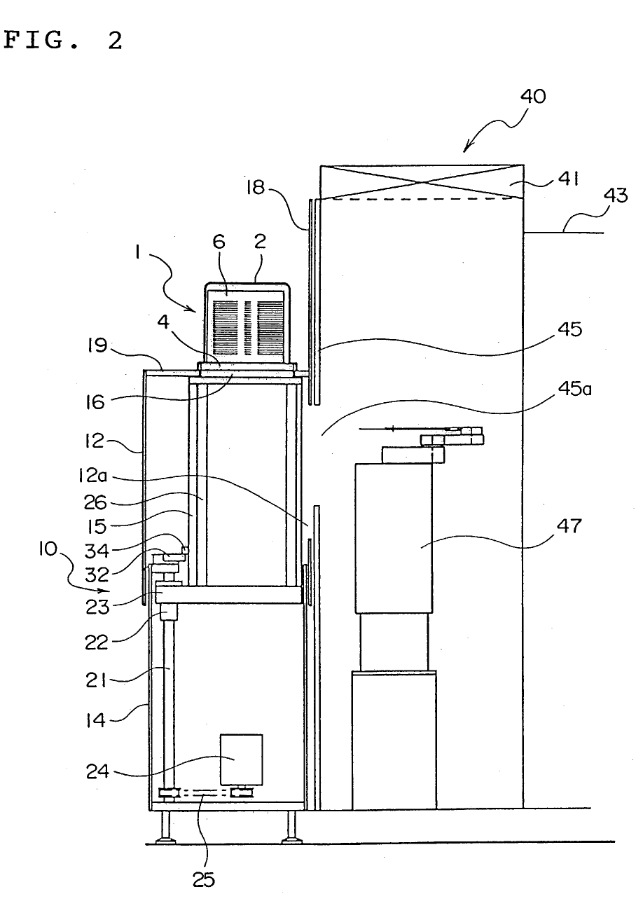

FIGS. 1 to 3 show a mini-environment system of a semiconductor processing apparatus as an embodiment of the present invention, under its different operation stages respectively. The semiconductor processing apparatus (which will be simply referred to as a processing apparatus hereinafter) is an apparatus that performs a specific processing on semiconductor wafers that have been loaded into the apparatus. In FIGS. 1 to 3, the housing of each component of the system is shown in cross section in order to show the inner structure of the system. The system is composed of a processing apparatus 40, a load port 10 attached to the front plate 45 of the processing apparatus 40, and a pod (i.e. a clean box) 1 set on the load port. In the following, the structure of the system will be described with reference mainly to FIG. 2.

The load port 10 is provided with a stationary housing that is immovably fixed to the processing apparatus 40 and a movable housing 12 that is adapted to be moved up and down in the vertical direction relative to the stationary housing 14. The pod 1 is placed on a pod base 19 provided on the top face of the movable housing 12 of the load port.

The pod is composed of a pod body 2 in the form of a box that has an opening at the bottom and a lid 4 that closes the bottom opening of the pod body 2. On the lid 4, there is provided a cassette (or a wafer rack) 6 fixed thereto. The cassette 6 is a structure that has a plurality of shelves on which a plurality of wafers are accommodated in parallel with equal spaces.

The pod base 19 provided on the top face of the load port has an opening, which is closed by the cassette base 16. The pod 1 is placed on the pod base 19 in such a way that the lid 4 of the pod 1 is aligned with the cassette base 16. The cassette base 19 is supported by support posts 26. The support posts are fixed to an elevator base 23.

In the interior of the load port, there is provided an up-and-down drive mechanism for moving the elevator base 23 up and down. A description will be made here of this mechanism. As a motor 24 rotates, its driving force is transmitted by a transmission mechanism 25 to a ball screw 21 to rotate the ball screw. With the rotation of the ball screw 21, the translating nut 22 is driven in the longitudinal direction of the ball screw, that is, the vertical (or up-and-down) direction. The elevator base 23 is fixed to the translating nut 22, and therefore it is driven to move up and down together with the translating nut 22.

At the top portion of the ball screw 21, there is provided a stopper 32 for retaining the elevated movable housing 12 at its elevated position. The stopper 32 is adapted to be moved by an air cylinder (not shown) in the right and left direction of the drawing. The stopper 32 is configured to cooperate with a stop bar 34 fixed to a plate 15 that is attached to the pod base 19 so as to retain the movable housing at its elevated position. The operations in connection with this process will be described later.

The movable housing 12 of the load port is provided with an opening 12a on its side surface facing the processing apparatus. In addition, the movable housing is also provided, above that opening, with a cover plate 18 on its side surface facing the processing apparatus. The cover plate 18 is provided for closing an opening 45a of the processing apparatus, when the movable housing is in its lowered position.

At the top portion of the processing apparatus 40, there is provided an air intake fan device 41 having a filter. The air intake fan device 41 continuously creates down flow of air to maintain a clean condition in the processing apparatus. The down flow of air is exhausted from the bottom of the apparatus to the exterior. Inside the processing apparatus, there is provided a transferring robot 47 for picking up a wafer from the cassette 6 of the pod that is set on the load port 10 and transferring it to a processing portion 43 (which is shown only schematically) of the processing apparatus that actually performs processing on the wafer.

The side wall 45 of the processing apparatus that faces the load port has the opening 45a through which the wafer is transferred from the load port into the processing apparatus.

In the following a description will be made of the operation of the above-described mini-environment system according to this embodiment with reference to FIGS. 1 to 3.

Firstly, as shown in FIG. 1, the pod 1 is placed on the pod base 19 of the load port under the state in which the movable housing 12 and the elevator base 23 of the load port are in their lowermost position. Since pods are carried and set on the load port manually by a worker in many cases, it is preferable that the position of the pod base be relatively low to some extent when the pod is to be set. Therefore, the pod is set under the state in which the movable housing is in its lowermost position.

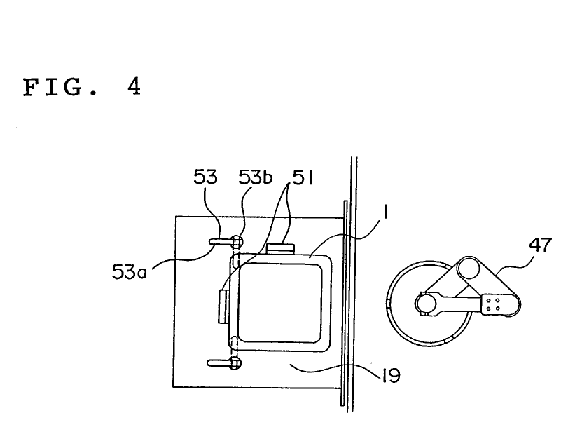

Referring to FIG. 4, which is a plan view for the arrangement shown in FIGS. 1 to 3, the pod 1 is placed on the pod base 19 in such a way that the pod is positioned to a prescribed position by pod guides 51. Under this state, the lid 4 of the pod and the cassette base 19 of the load port are in alignment with each other. Then, the pod is locked to the pod base by a pod locking mechanism 53. In the pod locking mechanism 53, lock arms 53a pivot about their axes 53b from the positions depicted by broken lines in FIG. 4 to the positions depicted by solid lines, so that they engage the pod body 2 to lock it. Then the lid 4 of the pod is vacuum attached to the cassette base by a suction mechanism (not shown). Thus, the setting of the pod 1 to the load port 10 is completed. In this state, the side opening 45a of the processing apparatus 40 is closed by the cover plate 18 of the load port.

Next, the motor 24 (shown only in FIG. 2) is activated to rotate the ball screw 21, so that the translating nut 22 and the elevator base 23 fixed thereto are moved upward. With this movement, the movable housing 12 and the pod I set thereon are elevated together with the support posts 26 and the cassette base 16. When the stop bar 34 comes to a position higher than the stopper 32, the upward movement of the elevator base is stopped, and the stopper 32 is slid toward the stop bar 34 to a position at which the stopper 32 can engage with the stop bar 34. This is the state shown in FIG. 2. In this state, the opening 45a of the processing apparatus 40 and the opening 12a of the load port 10 are in alignment with each other. Under this state, the securing engagement of the lid 4 to the pod body 2 is released by a lid opening/closing mechanism (not shown) provided on the cassette base 16. There are various systems for securing the lid 4 to the pod body 2, such as a latch system using a latch(es) or a suction system etc., and the opening/closing mechanism would be structured in various ways accordingly. However, detailed descriptions and illustrations of the securing systems are omitted here, since such systems and opening/closing mechanisms therefore per se are well known. In connection with this, the release of the securing engagement of the lid may be performed not under the state shown in FIG. 2 but under the state shown in FIG. 1 or under a transitional state from the state of FIG. 1 to the state of FIG. 2.

Under the state shown in FIG. 2, the motor 24 is activated to rotate the ball screw 21, so that the translating nut 22 and the elevator base 48 are moved down. In this process, the movable housing 12, the pod base 19 and the pod body 2 set on the pod base 19 remain at their elevated position shown in FIG. 2 due to the engagement of the stopper 32 and the stopper base 34, and only the cassette base 16 that is supported on the elevator base 23 via the support posts 26 and the lid 4 and the cassette 6 that are held on the cassette base 16 are lowered. They are lowered until the cassette 6 comes to a vertical position aligning with the communication path opening (which is constituted by the load port opening 12a and the processing apparatus opening 45a) that allows communication between the load port and the processing apparatus, and stopped at that position. In connection with this, it is preferable that the height (or level) of the cassette under this state, in other words, the height of the communication path allowing the communication between the load port and the processing apparatus be arranged close to the height at which wafers transferred into the processing apparatus are set in the apparatus. This is because by so arranging the height, the transferring robot 47 is not required to move up and down to a large extent upon transferring operation.

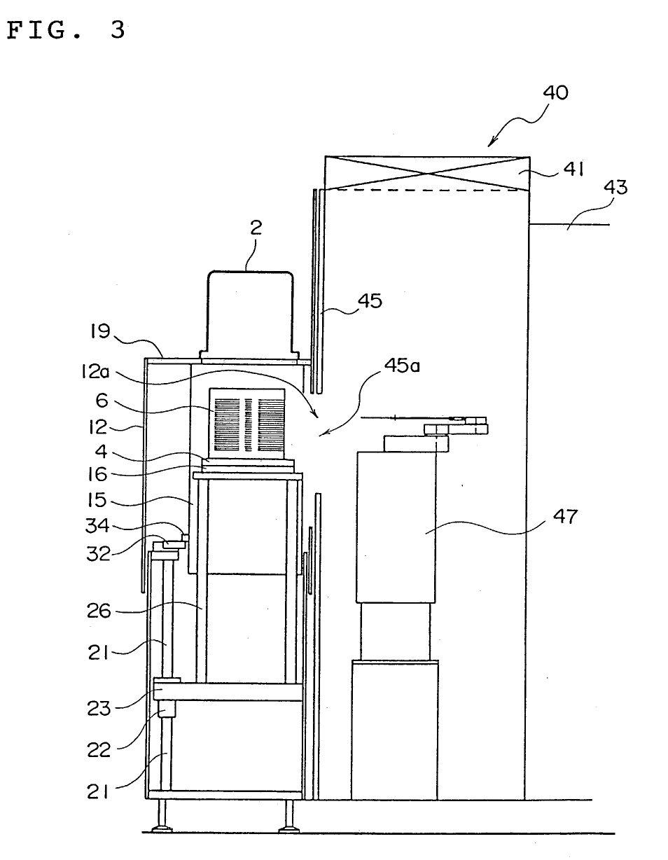

Under the state shown in FIG. 3, the transferring robot 47 of the processing apparatus 40 picks up a wafer on the wafer rack 6 to transfer it to the body portion 43 of the processing apparatus.

Then the wafer is subjected to a prescribed processing in the processing apparatus. The wafer having been processed in the processing apparatus 40 is returned onto the wafer rack by the transferring robot. Then, the process follows the sequence reverse to the sequence described above, namely, the state of the system changes from the state shown in FIG. 3 to the state shown in FIG. 1 via the state shown in FIG. 2.

Specifically, first in the state shown in FIG. 3, the up-and-down drive mechanism is activated to elevate the lid 4 of the pod and the cassette 6 together with the cassette base 16, so that the state shown in FIG. 2 is realized. In the state shown in FIG. 2, the stopper 22 is retracted in the left direction in the drawing to release its engagement with the stop bar 34. Then, the elevator base 23 is lowered by the up-and-down drive mechanism, whereby the movable housing 12, pod base 19 and the pod body 2 fixed thereto are also lowered together with the cassette base on the support posts and the cassette portion thereon (i.e. the lid 4 and the cassette 6), so that the state shown in FIG. 1 is realized. In the state shown in FIG. 1 or FIG. 2, or alternatively in a transitional state from the state of FIG. 2 to the state of FIG. 1, the lid opening/closing mechanism (not shown) is activated to secure the lid 4 of the pod to the pod body.

Subsequently, the suction of the lid 4 by the lid suction mechanism (not shown) provided on the cassette base is released, and the locking of the pod 1 by the pod locking mechanism 53 is also released. Thus, the pod 1 becomes detachable from the load port.

Preferably, the above described operations of the system is automatically performed in sequence under control by a control system (not shown).

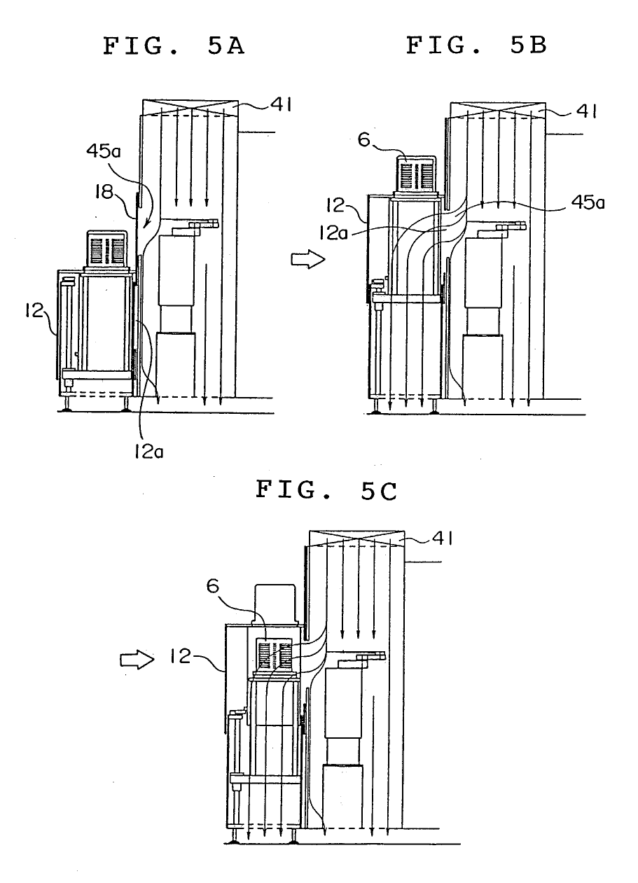

FIGS. 5A to 5C schematically show flows of air in the interior of the processing apparatus and the load port in the above-described process. In FIGS. 5A, 5B and 5C, which correspond to FIGS. 1, 2 and 3 respectively, flows of air are shown by arrows. In the state shown in FIG. 5A, the opening 45a of the processing apparatus provided on the load port side of the apparatus is closed by the cover plate 18 of the load port. Therefore, the down flow of air created by the air intake fan device 41 is flowing downward stably only inside the processing apparatus.

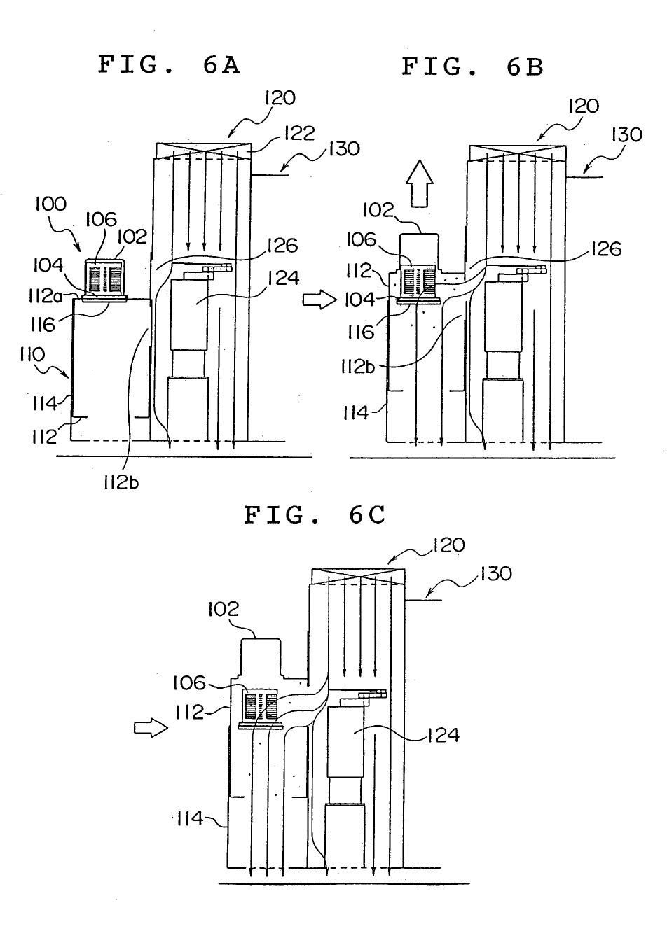

During the transition toward the state of FIG. 5B, as the movable housing 12 is elevated, the opening 12a of the load port and the opening 45a of the processing apparatus are gradually aligned with each other, whereby the communication path between the processing apparatus and the load port that is formed by the load port opening 12a and the processing apparatus opening 45a is opened. The communication path is gradually enlarged up to its maximum in the state shown in FIG. 5B. When the communication path between the processing apparatus and the load port is opened, the down flow of air in the processing apparatus flows also into the load port. During the transitional process from the state of FIG. 5A to the state of FIG. 5B, since the communication path is gradually enlarged, the airflow changes continuously. In other words, the airflow is unstable, and therefore blowing-up of particles occurs. Nonetheless, unlike with the conventional structure shown in FIGS. 6A to 6C, in the structure according to the present invention, the cassette that accommodates the wafers is still housed in the pod during that process. Therefore, the cassette is not exposed to the disturbed flow that involves particles, and so it will not be contaminated with particles.

After the communication path is opened fully and the airflow is stabilized in the state shown in FIG. 5B, the cassette portion is lowered, so that the state shown in FIG. 5C is realized. In this state, the wafers in the cassette are exposed to the airflow. However, since the pod is opened and the cassette is brought out after the communication path is opened fully and the airflow has been stabilized, the blowing-up of particles are not present. Therefore, the possibility of contamination of the wafers is low.

While the present invention has been described in the foregoing in conjunction with one embodiment thereof, it should be noted that the description has been made for an explanatory purpose and the present invention is not limited to the details of the embodiment.

For example, while in this embodiment a motor is used as a driving source for the up-and-down drive mechanism, other driving sources such as an air cylinder may also be used.

In the local clean system, the operating method thereof and the load port according to the present invention, the clean box is opened and the cassette is brought into the load port after the communication path between the load port and the processing apparatus is opened, namely, under the state in which the movable housing is retained at a predetermined elevated position and the communication path between the load port and the processing apparatus has been formed into a constant size. Therefore, the airflow to which the wafers accommodated in the cassette are exposed inside the load port has been already stabilized. Thus, the possibility of wafer contamination due to blowing-up of particles caused by disturbance of airflow is reduced.

Furthermore, in the local clean system and the load port according to the present invention, the up-and-down drive mechanism can be structured to push up the movable housing from beneath the position of the clean box or the cassette base. This means that the up-and-down drive mechanism does not exist above the cassette. Therefore, the possibility of wafer contamination with the particle generated by sliding of parts in that mechanism is low.

Still further, in the local clean system and the load port according to the present invention, the driving performed by the up-and-down drive mechanism is a single-shaft (or one-dimensional) driving, and the movable housing is only elevated on the cassette base and retained by the stopper. This process does not requite any additional driving mechanism. Therefore, the mechanism is not costly as compared to conventional apparatus, no matter whether the mechanism is constructed as a motor driving mechanism or an air cylinder mechanism.

What is claimed is:

1. An operating method of a local clean system including a processing apparatus, a load port annexed thereto and a clean box set on the load port, comprising the steps of:
setting the clean box on the load port;
opening a communication path between the load port and the processing apparatus;
opening, after said communication path is opened fully, the clean box and bringing a cassette in which a wafer is accommodated from the clean box into an interior of the load port; and
taking the wafer out of the cassette and transferring the wafer into the interior of the processing apparatus.

2. An operating method of a local clean system that includes a processing apparatus, a load port annexed thereto and a clean box set on the load port, wherein said processing apparatus has an opening on its side that faces the load port, said load port is provided with a movable housing portion having a top face on which the clean box is to be set and movable up and down in the vertical direction, said movable housing portion has an aperture on its side that faces the processing apparatus, the positional relationship between the opening of the processing apparatus and the opening of the movable housing portion is arranged in such a way that when the movable housing portion is at a predetermined elevated position, both the openings are aligned with each other to form a communication path between the load port and the processing apparatus, and said clean box includes a body in the form of a box having an opening at its bottom, a lid closing the opening of said body and a cassette for accommodating a wafer disposed on said lid, the method comprising the steps of:
setting the clean box on the top face of said movable housing portion of the load port under the state in which said movable housing portion is at a predetermined lowered position;
elevating said movable housing portion up to said elevated position to open the communication path between the load port and the processing apparatus, and retaining the movable housing portion at that position;
opening, under the above-described state, the lid of the clean box and lowering the lid and the cassette thereon to bring them into the interior of the load port; and
picking up the wafer from said cassette and transferring it to the processing apparatus.

3. A local clean system comprising:
a processing apparatus;
a load port annexed thereto; and
a clean box set on the load port;
wherein, said processing apparatus has an opening on its side that faces the load port;
said load port is provided with a movable housing portion having a top face to which the clean box is to be set and movable up and down in the vertical direction, an up-and-down drive mechanism that moves said movable housing portion up and down, and a stopper for retaining said movable housing portion at a predetermined elevated position, said movable housing portion having an aperture on its side that faces the processing apparatus, the positional relationship between the opening of the processing apparatus and the opening of the movable housing portion being arranged in such a way that when the movable housing portion is at a predetermined elevated position, both the openings are aligned with each other to form a communication path between the load port and the processing apparatus; and
said clean box includes a body in the form of a box having an opening at its bottom, a lid closing the opening of said body and a cassette for accommodating a wafer disposed on said lid.

4. A local clean system according to claim 3, wherein said up-and-down drive mechanism can lower the lid of the clean box set on the top face of the movable housing portion downward together with the cassette disposed thereon under the state in which the movable housing portion is retained by the stopper at its elevated position, to bring them into the interior of the load port so that said cassette and said communication path would be at substantially the same height.

5. A local clean system according to claim 4, wherein an opening is provided on the top face of said movable housing portion, and said load port has a cassette base that closes said opening on the top face of the movable housing portion, and said up-and-down drive mechanism is joined to said cassette base so that when the cassette base is elevated, the movable housing portion would be pushed up together with the cassette base, and it is possible to lower only the cassette base together with the lid of the clean box and the cassette while the movable housing portion is retained by the stopper at the elevated position.

6. A load port for use in a local clean system in conjunction with a processing apparatus, comprising:
a movable housing portion having a top face on which a clean box is to be set and movable up and down in the vertical direction;
an up-and-down drive mechanism that moves said movable housing portion up and down; and
a stopper for retaining said housing at a predetermined elevated position;
wherein said movable housing portion having an aperture on its side that faces the processing apparatus, said opening is configured in such a way that when the movable housing portion is at a predetermined elevated position, said opening is in alignment with an opening of said processing apparatus to form a communication path between the load port and the processing apparatus, and the load port can lower the lid of the clean box set on the top surface of the movable housing portion downward together with a cassette disposed thereon under the state in which the movable housing portion is retained by said stopper at its elevated position to bring them into the interior of the load port so that said cassette and said communication path would be at substantially the same height

7. A load port according to claim 6, wherein an opening is provided on the top face of said movable housing portion, and said load port has a cassette base that closes said opening on the top face of the movable housing portion, and said up-and-down drive mechanism is joined to said cassette base so that when the cassette base is elevated, the movable housing portion would be pushed up together with the cassette base, and it is possible to lower only the cassette base together with the lid of the clean box and the cassette while the movable housing portion is retained by the stopper at the elevated position.
